(19) United States
(12) Patent Application Publication
(10) Pub. No.: US 2004/0141587 A1
(43) Pub. Date: Jul. 22, 2004

(54) Particle detector and associated particle detection method

(75) Inventors: Marc Arques, Grenoble (FR); Anthony Bardet, Grenoble (FR)

Correspondence Address: PEARNE & GORDON LLP, 1801 EAST 9TH STREET, SUITE 1200, CLEVELAND, OH, 44114-3108, US

(73) Assignee: Commissariat a L'Energie Atomique, Paris (FR)

(21) Appl. No.: 10/716,779

(22) Filed: Nov. 19, 2003

(30) Foreign Application Priority Data
Nov. 27, 2002 (FR) 02 14882

(51) Int. Cl. H05G 1/64

(52) U.S. Cl. 378/98.8

(57) ABSTRACT

This invention relates to a particle detector comprising counting means (4).

The detector comprises:

means (7b) of creating an electrical pulse (Vb) from a detected particle, forming an inhibition. signal inhibiting at least one neighboring detector to prevent the neighboring detector from detecting the same particles, and

means (8, 9) of inhibiting the detection of particles under the action of an inhibition signal originating from at least one neighboring detector.

Some applications of the invention are in the radiology field (X-ray, radioscopy).

### TECHNICAL DOMAIN AND PRIOR ART

This invention relates to a particle detector outputting counting information about a number of detected particles and a particle counting device comprising several particle detectors.

The invention also relates to a process for reading a matrix of particle detectors according to the invention.

Some applications of the invention are in the radiology field (X-ray, radioscopy).

The detected particles are then X-rays.

X-ray detectors comprise an element that absorbs X-rays and transforms them into electrical pulses. In matrix detectors used for counting, these electrical pulses are processed (amplified and filtered, etc.) and then transmitted to a comparator that delivers a digital electrical pulse for each detected particle. FIG. 1 shows a particle detector according to prior art and FIG. 2 shows a particle counting device comprising several particle detectors according to prior art.

The particle detector, also called a “detector pixel”, shown in FIG. 1 comprises an element 1 that absorbs particles, a processing circuit 2, a comparator 3 and a counter 4. The element 1 comprises one or several detection layers that absorb particles P, for example X-rays, and transform them into electrical pulses. For example, element 1 may be a semiconducting element, a gas, a scintillator associated with a semiconductor, etc. The processing circuit 2 processes electrical pulses (amplification, filter, etc.) and the comparator 3 compares each electrical pulse delivered from the processing circuit 2 with a threshold voltage Vs. The comparator 3 thus outputs a digital electrical pulse derived from the electrical pulse delivered from the processing circuit 2. Digital electrical pulses increment the counter 4. At the end of irradiation, the counter 4 contains information representing the number N of detected particles.

FIG. 2 shows a particle counting device comprising several particle detectors according to known art. The counting device is arranged in the form of a matrix (detector rows and columns). A row addressing offset register 5 controls reading of counters 4, row by row. Counting information output by the counter 4 is transmitted to a column multiplexer 6, column by column.

The particle detector counter 4 must be incremented by 1 for each particle detected in the semiconducting element 1. Not incrementing the counter is equivalent to not using the detected particle, and consequently degrading the statistics and quality of the image produced. In this case, it is necessary to increase the dose delivered to the patient, in order to maintain this quality, and this is not desirable.

Similarly, increasing the counters of two neighboring detector pixels when only one particle is absorbed is equivalent to “inventing” a particle. This is just as bad as not counting a particle in terms of “image quality”.

When a particle is absorbed at a location close to the boundary between two neighboring detector pixels, the charges output may be distributed in absorption layers of two neighboring pixels, mainly due to diffusion phenomena. Two particles are then counted whereas only one should have been counted. This problem is particularly severe if the dimensions of the detector pixels are small, which is the case for example in mammography. Since technological developments are leading to miniaturization of circuits, this problem will arise more and more frequently in other applications.

One known solution that works well with synchrotron radiation sources and with silicon or gallium arsenide detection layers consists of adjusting the threshold of the comparator 3 as closely as possible to an amplitude equal to half the amplitude of the electrical pulse that generates the detected particle. In this case, only the detector pixel that collected more than half of the charges will count the particle. This solution solves many cases. However, the problem in which particles detected very close to the boundary between two neighboring pixels and the problem of adjustment dispersion still need to be solved.

Another disadvantage of this solution is that it is not applicable to classical radiology fields, for two reasons. Firstly, X-ray generator tubes emit a continuous energy spectrum. The ratio between the maximum transmitted energy and the minimum transmitted energy is typically 2 to 3. Therefore, it is meaningless to define half of an amplitude of a “standard” photon. Detector materials may then be semiconductors with a lower quality than silicon or gallium arsenide, for example such as Se, CdTe, PbO, PbI2, HgI2, T1Br. In these materials, transport properties of electronic charges are mediocre and the charge read finally depends on the absorption depth of the X photon in the layer. This depth may vary significantly and randomly from one absorbed photon to another. In this case too, it is meaningless to define an amplitude equal to half the amplitude of a detected photon.

The invention does not have the disadvantages mentioned above.

### Presentation of the Invention

The invention relates to a particle detector comprising means of delivering a first electrical pulse starting from a detected particle, and means of counting first electrical pulses thus delivered. The detector comprises:

means of creating a second electrical pulse forming a detection inhibition signal transmitted to at least one neighboring detector to prevent the neighboring detector from detecting the detected particle that corresponds to the first delivered electrical pulse, starting from a detected particle, and

means of inhibiting the detection of particles under the action of an inhibition signal originating from at least one neighboring detector.

According to one additional characteristic of the invention, the means of inhibiting particle detection comprise:

a first switch installed on the input side of counting means, and

a control circuit that outputs a control signal for the first switch as a function of inhibition signals output from neighboring detectors.

According to another additional characteristic of the invention, the control circuit is a “NOR” or “OR” logical gate, and the inhibition signals output from neighboring detectors are applied to the inputs of this logical gate.

According to another characteristic, the detector comprises:

means of preventing the transmission of the inhibition signal to the neighboring detector if the first delivered electrical pulse corresponds to a predetermined energy, and

means of preventing counting of the first delivered electrical pulse corresponding to the predetermined energy, under the action of an inhibition signal derived from a neighboring detector and received in a time window with a predetermined duration beginning with detection of the first electrical pulse.

According to another additional characteristic, the means of preventing transmission of the inhibition signal to the neighboring detector comprise:

a second switch that receives the second electrical pulse on a first terminal and for which a second terminal is connected to at least one input of at least one control circuit of a neighboring detector, and

a circuit for evaluating the predetermined energy, in which the output signal forms a control signal for the second switch,

the means of preventing counting of the first delivered electrical pulse (Va) comprising delay means placed on the input side of the first switch.

According to one additional characteristic of the invention, the predetermined energy is a fluorescence photon energy.

According to one additional characteristic of the invention, the duration of the second electrical pulse is longer than the duration of the first electrical pulse.

The invention also relates to a particle counting device comprising several particle detectors according to the invention.

According to an additional characteristic of the counting device, the particle detectors are arranged in the form of a matrix of detectors.

According to another additional characteristic, the detectors adjacent to a detector Dij located at the intersection of the row rank i and column rank j of the matrix of detectors are detectors Di(j−1), Di(j+1), D(i−1)j, D(i+1)j.

The invention also relates to a process for reading a particle detector matrix, characterized in that when a first detector detects a particle, it includes an inhibition step for at least one second particle detector adjacent to the first particle detector.

According to another characteristic, the read process comprises a step to evaluate if a first electrical pulse (Va) delivered by the first particle detector has a predetermined energy, and if so to avoid implementing the inhibition step and not counting the first delivered electrical pulse (Va) if the second particle detector detects a particle in a time window with a predetermined duration beginning with detection of the first particle by the first detector.

According to another characteristic, the predetermined energy is a fluorescence photon energy.

### BRIEF DESCRIPTION OF THE FIGURES

Other characteristics and advantages of the invention will become clear after reading a preferred embodiment of the invention with reference to the attached figures among which:

FIG. 1 shows a particle detector outputting counting information about a number of particles detected according to known art;

FIG. 2 shows a particle counting device comprising several particle detectors according to known art;

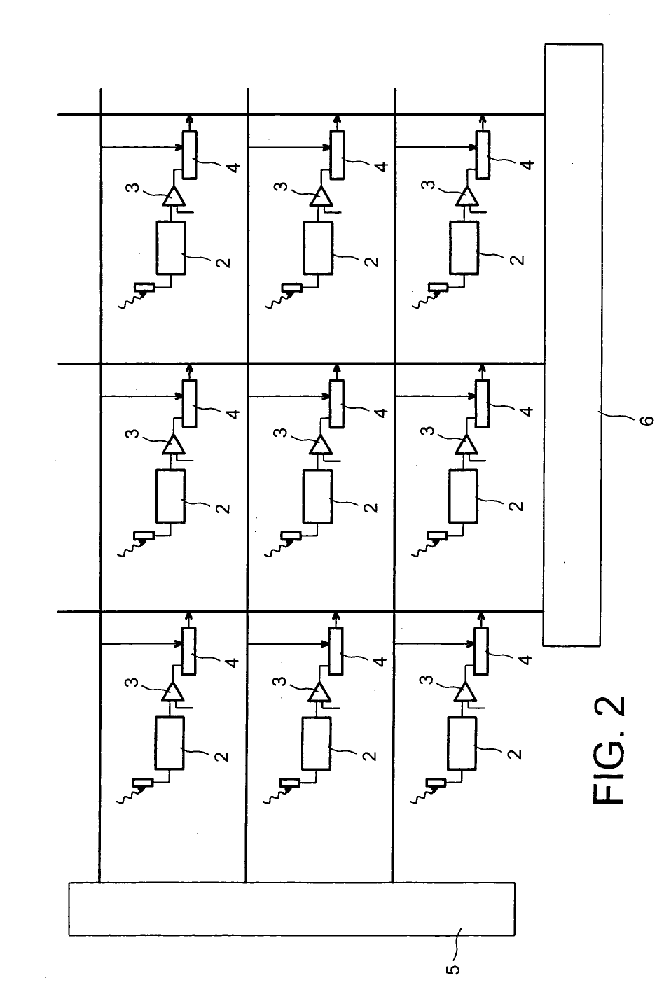

FIG. 3 shows a particle detector according to the invention;

FIGS. 4A, 4B and 4C show an example of signals present in a particle detector for use of the invention;

FIG. 5 shows an improvement to the particle detector shown in FIG. 3.

The same marks denote the same elements in all figures.

### DETAILED DESCRIPTION OF EMBODIMENTS OF THE INVENTION

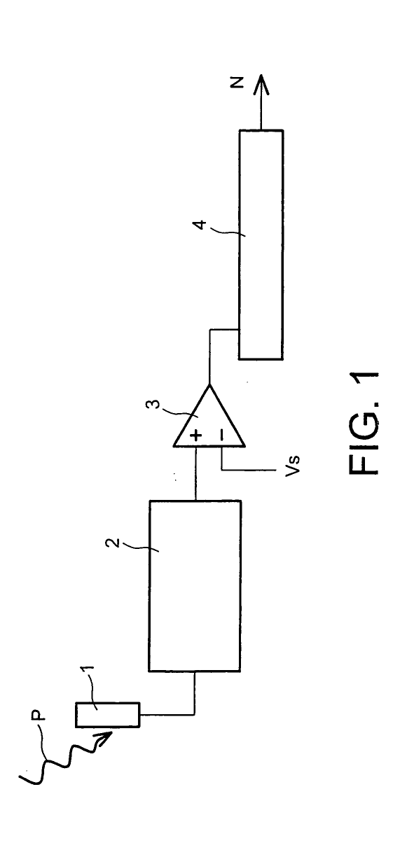

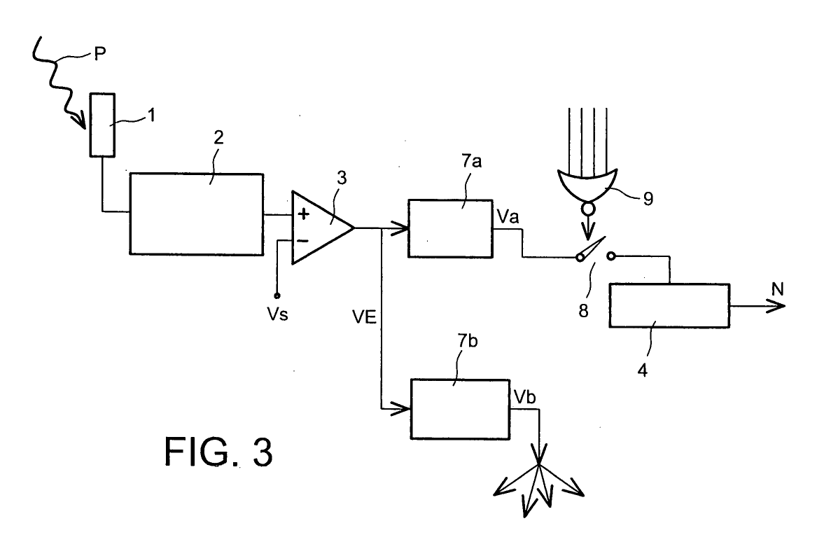

FIG. 3 represents a particle detector according to the invention. In addition to the elements shown in FIG. 1, the particle detector comprises means 7a and 7b of forming a first pulse Va and a second pulse Vb respectively, starting from the electrical pulse VE delivered by the comparator 3, a switch 8 and a control circuit 9.

The switch 8 is placed on the input side of the counter 4, between the output from circuit 7a and the input to counter 4. The output from the control circuit 9 outputs the control signal for the switch 8.

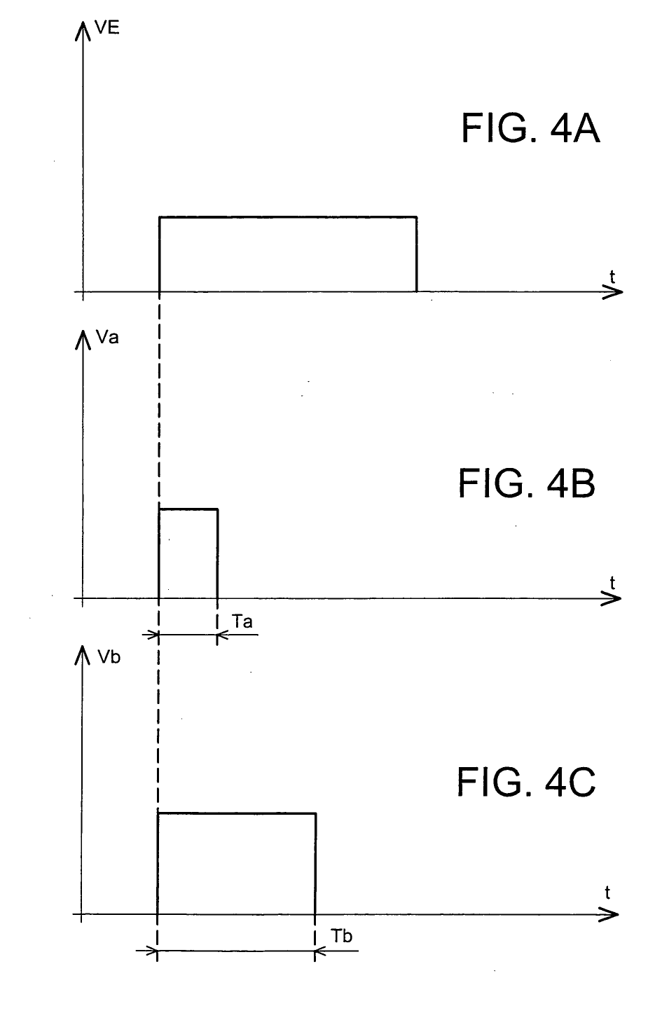

The first pulse Va forms a signal designed to be counted by the counter 4. The second pulse Vb forms a count inhibition signal transmitted to one or several neighboring detectors. Pulses Va and Vb formed from the electrical pulse VE have predetermined durations of Ta and Tb respectively. For example, pulses VE, Va and Vb are shown in FIGS. 4A, 4B and 4C.

The signal Va that represents the detected pulse is intended to increment the counter 4. The duration Ta of the signal Va is chosen to be relatively short, while enabling the signal Va to be taken into account correctly by the counter 4 (the duration Ta may for example thus be equal to 5 ns). The signal Vb forms a “window” signal that will inhibit detection of neighboring pixels in order to inhibit them from detecting the particle detected by the electrical pulse Va. Consequently, the duration Tb of the inhibition pulse formed in a given detector pixel is greater than the duration Ta of detection pulses formed in neighboring detector pixels. The duration Tb is thus such that:

Tb≧Tr+Ta+Td, where

Ta is the duration of pulse Va or the neighboring pixel(s);

Tr is the estimated maximum delay for detection of a neighboring pixel when it detects a fraction of charges corresponding to the same particle;

Td is a safety factor taking account of technological dispersions of particle detectors.

Although the duration Tb is relatively “long”, it is chosen to be sufficiently “short” so that neighboring pixels are reset into a state to count new particles as quickly as-possible. For example, the duration Tb for a pixel for which the duration Ta is equal to 5 ns (see above) may then be equal to 20 ns.

The signal Tb is transmitted to neighboring detectors, in other words for example detectors located on the four sides of a detector (at the top, bottom, right and left of the detector respectively in the case of detectors grouped in the form of a matrix). It is also possible to define any other neighborhood, particularly including pixels in oblique directions.

In the same way as a detector pixel sends the inhibition signal Tb to p neighboring detectors (for example p=4), it also receives p inhibition signals from these same p neighboring detectors. The p inhibition signals originating from the neighboring detectors form input signals to the control circuit 9 for which the output signal controls the switch 8. Thus, the switch 8 opens preventing counting of counter 4 as soon as a neighboring detector detects a particle.

The control circuit 9 of the switch 8 is then a “NOR” gate (case of FIG. 3) when the switch is conducting when it is controlled by a logical level 1. If a logical level 0 makes the switch 8 conducting, the control circuit 9 is an “OR” gate.

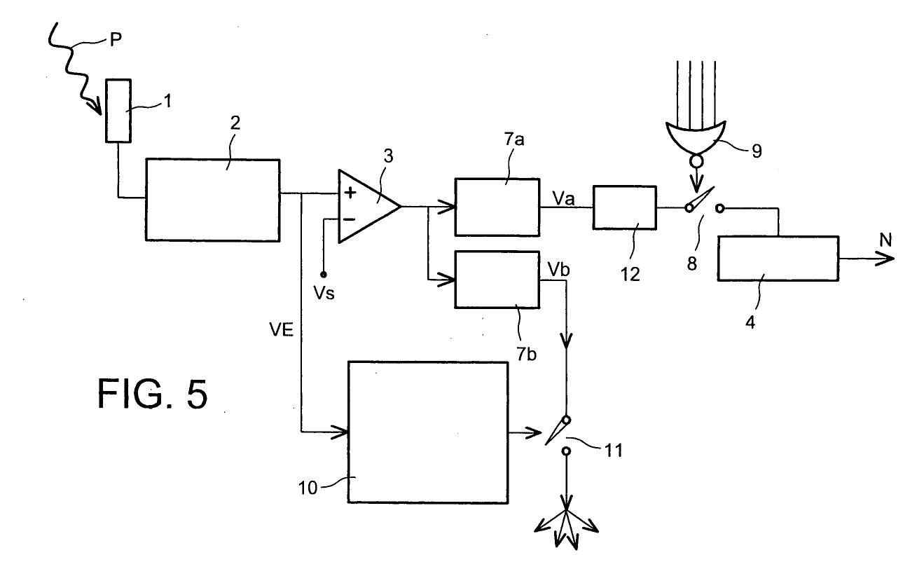

FIG. 5 shows an improvement to the particle detector shown in FIG. 3.

The detector according to the improvement shown in FIG. 5 solves the problem of particle detection (X-rays) related to the existence of parasite particles with a predetermined energy, for example such as fluorescence photons.

Fluorescence photons are generated in the absorption layer in which X-photons are detected. An initial X photon interacts with an atom in the absorption layer at a first location where it deposits part of its energy. Almost instantaneously, the atom then sends a de-excitation photon called a fluorescence photon that may either escape from the absorption layer (and therefore be lost) or be absorbed in a second location, slightly further on in the absorption layer.

If the fluorescence photon escapes, it is advantageously not detected. All that is necessary is to make sure that the energy deposited at the first location is sufficient to trigger counting.

It is not a disadvantage if the fluorescence photon is re-absorbed in the same detector pixel, since the charges deposited at the two locations are finally accumulated in the same reading amplifier.

However, if the fluorescence photon is absorbed in the absorbent layer of a neighboring detector pixel, there may be a risk of double detection. The detector according to the invention described above retains the pixel that makes the first detection and consequently inhibits its neighbor. Usually, the fastest detector pixel is the one that picks up the most energy. A fluorescence photon frequently has a higher energy than the energy deposited by the initial photon. Therefore the detector described above more often retains the absorption point of the fluorescence photon. This is not as serious as double counting, but it is an error in the position of the detected photon and the spatial resolution of the sensor is correspondingly degraded.

The improvement to the invention described below advantageously makes it possible to choose the initial photon as the detected photon. FIG. 5 shows a detector according to the improvement to the invention.

In addition to the elements described in FIG. 3, the detector according to the improvement in the invention comprises a second switch 11, an evaluation circuit 10 and a delay circuit 12. The second switch 11 is placed on the output that outputs the inhibition signal Vb. The evaluation circuit 10 receives the signal output by the processing circuit 2 on its input while the signal that it outputs forms a control signal for switch 11. The delay circuit 12 is placed between the output from the circuit 7a that outputs a signal Va and the switch 8.

The improvement to the invention is based on the fact that the energy of fluorescence photons is a known magnitude that depends on the absorbent material. Consequently, the circuit 10 comprises a memory circuit in which different reference amplitude values of fluorescence photons are memorized. The VE signal output by the processing circuit 2 is then compared with these different values. If the evaluation of the amplitude of the signal VE is followed by the detected photon being identified as a fluorescence photon, the signal output by the evaluation circuit 10 controls opening of the switch 11. Transmission of the inhibition signal Vb to the neighboring pixels is then prohibited, thus leaving detection priority to these neighboring pixels.

The function of the delay circuit 12 is to add a delay in transmission of the pulse Va that represents the fluorescence photon. This delay gives the neighboring pixels sufficient time to transmit at least one control pulse to the control circuit 9. The switch 8 opens under the action of the control output by the circuit 9, thus preventing counting of the pulse Va that represents the fluorescence photon. However, the pulse Va is counted if no inhibition order comes from the neighboring detector pixels.

Note that the improvement to the invention can only reasonably be used if the element 1 and the processing circuits 2 and 3 are of sufficiently good quality for the pulse amplitude delivered by the processing circuit 2 to be considered as being representative of the deposited energy of the detected photon.

1. Particle detector comprising means (1, 2, 3, 7a) of delivering a first electrical pulse (Va) starting from a detected particle, and means (4) of counting first electrical pulses thus delivered, characterized in that it comprises:
means (7b) of creating a second electrical pulse (Vb) forming a detection inhibition signal starting from a detected particle, sent to at least one neighboring detector to prevent the neighboring detector from detecting the detected particle that corresponds to the first delivered electrical pulse (Va), and
means (8, 9) of inhibiting the detection of particles under the action of an inhibition signal originating from at least one neighboring detector.

2. Particle detector according to claim 1, characterized in that the means (8, 9) of inhibiting particle detection comprise:
a first switch (8) installed on the input side of the counting means (4), and
a control circuit (9) that outputs a control signal for the first switch (8) as a function of inhibition signals output from neighboring detectors.

3. Particle detector according to claim 2, characterized in that the control circuit (9) is a “NOR” or “OR” logical gate, and the inhibition signals output from neighboring detectors are applied to the inputs of this logical gate.

4. Particle detector according to claim 1, characterized in that it comprises:
means (10, 11) of preventing the transmission of the inhibition signal (Vb) to the neighboring detector if the first delivered electrical pulse (Va) corresponds to a predetermined energy, and
means (12) of preventing counting of the first delivered electrical pulse corresponding to the predetermined energy, under the action of an inhibition signal output from a neighboring detector and received in a time window with a predetermined duration beginning with detection of the first electrical pulse (Va).

5. Particle detector according to claim 4, characterized in that the means (10, 11) of preventing transmission of the inhibition signal to the neighboring detector comprise:
a second switch (11) that receives the second electrical pulse (Vb) on a first terminal and for which a second terminal is connected to at least one input of at least one control circuit (9) of a neighboring detector, and
a circuit (10) for evaluating the predetermined energy, in which the output signal forms a control signal for the second switch (11),
and in that the means (12) of preventing counting of the first pulse (Va) comprise delay means placed on the input side of the first switch (8).

6. Particle detector according to either claim 4 or 5, characterized in that the predetermined energy is a fluorescence photon energy.

7. Particle detector according to claim 1, characterized in that the duration (Tb) of the second electrical pulse (Vb) is longer than the duration (Ta) of the first electrical pulse (Va).

8. Particle counting device comprising several particle detectors, characterized in that the particle detectors are detectors according to any one of claims 1 to 7.

9. Particle counting device according to claim 8, characterized in that the particle detectors are arranged in the form of a matrix of detectors.

10. Particle counting device according to claim 9, characterized in that the detectors adjacent to a detector Dij located at the intersection of the row rank i and column rank j of the matrix of detectors are detectors Di(j−1), Di(j+1), D(i−1)j, D(i+1)j.

11. Process for reading a particle detector matrix, characterized in that when a first detector detects a particle, it includes an inhibition step to inhibit at least one second particle detector adjacent to the first particle detector.

12. Read process according to claim 11, characterized in that it comprises a step to evaluate if a first electrical pulse (Va) delivered by the first particle detector has a predetermined energy, and if so to avoid implementing the inhibition step and not count the first delivered electrical pulse (Va) if the second particle detector detects a particle in a time window with a predetermined duration beginning with detection of the first particle by the first detector.

13. Read process according to claim 12, characterized in that the predetermined energy is a fluorescence photon energy.
